(19) United States
(12) Patent Application Publication
(10) Pub. No.: US 2009/0295231 A1
(43) Pub. Date: Dec. 3, 2009

(54) Intelligent Power Collection Network

(76) Inventors: Shawn J. GAFFNEY, Park Ridge, IL (US); Richard W. GUNGEL, Roscoe, IL (US); Edward J. ENGLERT, Chana, IL (US)

Correspondence Address: DAVID I. ROCHE;BAKER & MCKENZIE LLP, 130 EAST RANDOLPH DRIVE, CHICAGO, IL, 60601, US

(21) Appl. No.: 12/463,100

(22) Filed: May 8, 2009

Related U.S. Application Data
(60) Provisional application No. 61/057,357, filed on May 30, 2008.
(60) Provisional application No. 61/074,951, filed on Jun. 23, 2008.

(51) Int. Cl. H02J 13/00; H02J 3/38; H02H 7/06

(52) U.S. Cl. 307/80; 307/84; 361/20

(57) ABSTRACT

Connecting a system of electrical generators into a network in order to yield at least some of the following benefits: reduced capital costs, reduced operating costs, enhanced system reliability, and automatic fault isolation. In one embodiment, a plurality of generators are provided wherein the output of each generator has substantially the same voltage and phase relationship. Multiple cables directly connect the generators to a power collection point, the cables forming a network that supplies power to the power collection point from at least two separate current paths.

### CROSS-REFERENCE TO RELATED APPLICATIONS

This application claims priority to U.S. Provisional Patent Application Nos. 61/057,357, filed May 30, 2008, and 61/074,951, filed Jun. 23, 2008, both of which are hereby incorporated by reference.

### FIELD OF THE INVENTION

The embodiments described and claimed herein relate generally to power networks. More specifically, some embodiments relate to a way of connecting a system of electrical generators into a network in order to yield at least some of the following benefits: reduced capital costs, reduced operating costs, enhanced system reliability, and/or automatic fault isolation. One embodiment, in particular, relates to an intelligent power collection network that has applicability to wind-powered electrical generation facilities as well as other power networks.

### BACKGROUND

For any power collection or distribution system, it is generally assumed that power transmitted at a higher voltage will result in lower power losses. In light of that, it has been a common industry practice in the field of wind-powered electrical generation systems to use a step-up transformer at each wind turbine generator (WTG) so that the generator voltage is stepped up to the collection voltage level (typically 34.5 kV). Typically, six generators were connected in a radial string, as shown in prior art FIG. 1.

Unfortunately, this technique is expensive, because of the high number of transformers that must be purchased and installed. The use of a step-up transformer at each WTG is also not naturally fault-tolerant, because there is no parallel path for current to reach a collection point in the event of an upstream failure.

Therefore, although the prior art power collection systems provide satisfactory results, it is clear that the prior art systems suffer from one or more disadvantages, including high initial construction costs, high maintenance costs, and high operating costs. The embodiments disclosed and claimed herein are intended to solve at least some of these problems.

### BRIEF SUMMARY

Several embodiments of an intelligent power collection network are described and claimed herein that are based on a unique design process that finds a best lifecycle cost for a multi-generator power project by (1) reducing the initial costs of installing a generator collection system, (2) reducing operating losses, and/or (3) increasing system reliability. The reduced initial costs can be realized by using fewer, more efficient transformers, as well as better-cost cables and terminations. Reduced operating costs can be realized by reducing conductor current, by effectively providing parallel current paths. The redundant current paths can also increase the reliability of the system, thereby minimizing any operating losses that might result from outages. Protection can range from basic overcurrent to more sophisticated protection and automation schemes. In general, the more sophisticated the protection scheme, the more that downtime for equipment malfunctions can be reduced, thus minimizing unscheduled operating losses.

The process for optimizing the collection system can involve multiple iterations to find a best economic value for at least some of the following variables: (a) transformer size and quantity; (b) cable sizes, parallel conductors and lengths; (c) component availability and pricing; (d) site condition and installation costs; and/or (e) cost of money. Changing any of the variables may have a system-wide impact requiring the calculations to be repeated to converge to a better solution. In the end, this process results in best lifecycle costs by finding the best combination of the following:

a. Transformer size and quantity: Larger transformers, properly specified, have higher efficiencies. Transformers tend to be expensive, so costs are reduced by minimizing unnecessary transformers. However, cable lengths and cable losses mean that there is a convergence point such that it sometimes pays to add more transformers.

b. Cable sizes, parallel conductors and lengths. Heat losses increase as a squared function so it is best to minimize currents instead of upsizing cables or increasing voltage—if possible. Again, the best-point solution is a convergence of multiple variables.

c. Component availability and pricing reaches beyond theoretical engineering and into the reality of what is available in the time frame of the project.

d. Site condition and installation costs—parallel paths for difficult soil conditions may cause certain options to be less attractive.

e. Cost of money—most important and most commonly ignored by engineers is the time-value of money. The process described here optimizes the network configuration based on required rates of return and considers future savings discounted back for a present value.

There are three exemplary versions of an intelligent power network described, including a “basic” version, an “intermediate” version, and an “advanced” version. Each version includes certain combinations of features and benefits. However, other versions, which include some combination of the disclosed features and benefits, are contemplated even if such versions are not specifically identified and discussed herein.

For the “basic” version, the network configuration can be a combination of loops and radial circuits. One benefit of the basic version is that there will be a reduced initial cost due to a reduced number of transformers. In addition, operating costs will be reduced due to parallel current paths and lower cable losses.

For the “intermediate” version, the network configuration can be a combination of loops, including nested loops, and radial circuits. Network protection will reside at the transformers, with communication throughout the network. For a small added cost, parallel redundant paths can be obtained with intelligent switching to isolate faults. Most of the network can continue to operate after the fault is automatically isolated.

For the “advanced” version, the network configuration can be a combination of loops, including nested loops, and radial circuits. Network protection will reside at both the generators and the transformers. The network protection equipment can isolate individual faulted cables, transformers or generators, automatically taking them out of service. The network will be capable of continuing to operate all generators with only one cable out of service.

For all three versions, there are opportunities to reduce both initial costs and operating costs. For example, all three versions offer opportunities to reduce the number of transformers in a generation network. The primary difference between the three versions lies in their method of automatic fault isolation.

### DEFINITIONS

The following definitions are provided for convenience and are not intended to limit or otherwise re-define terms that are commonly known and understood by persons of ordinary skill to which this application pertains:

“52 Device”: A contactor, circuit breaker, vacuum fault interrupter or other similar device, designed to disconnect all three circuit phases at once. A 52 device is capable of interrupting fault current.

“Breaker (52 device) Failure Protection”: (This is sometimes referred to as “Local Breaker Backup (LBB)”.). A scheme where the state of a circuit breaker or 52 device is monitored to confirm that it opened after it received a TRIP command. If the breaker fails to trip within a definite time interval (typically 15 electrical cycles), then an alternate breaker is tripped instead. In some systems, control of the generator breaker/contactor might be included. In this case, the generator circuit breaker could be included in the LBB scheme, as well. If one of the cable breakers failed to trip, the generator breaker could be tripped. Conversely, if the generator breaker failed to trip, both cable breakers could be commanded to trip, thereby disconnecting the generator from the system.

“Cable Fault”: A cable fault condition results, for example, from failure of the cable insulation, either due to an internal fault (thermal failure of insulation) or from physical damage such as damage caused by digging equipment. The fault could be phase-to-phase or phase-to ground.

“Cable Overload”: A condition in which the cable carries current in excess of its ampacity. This condition, if not reversed or interrupted by control or protection systems can lead to thermal damage of the cable insulation, and ultimately, cable failure.

“Differential Protection”: A protection scheme where the currents entering and leaving a cable are compared. If the two currents are not equal, a fault is present.

“LBB”: See Breaker (52 device) Failure Protection.

“Loop Configuration”: A configuration in which each generator has two paths for its output current to reach the collection system. This configuration exhibits improved reliability and lower cable power losses than the radial configuration. An example of a loop configuration is shown in FIG. 2.

“Network Fault”: An overcurrent fault occurring in a network cable, generator or transformer.

“Node”: A point in a network circuit at which power from a generator is injected into the network, or at which power is removed from the network for connection to the electrical grid. Electrically, a node is a bus where three branches are combined. Physically, a node in the “advanced” system includes protective relays with communications and logic required to implement the desired operating sequence.

“Radial Configuration”: A network configuration in which each generator sees only one possible path to the collection system. See FIG. 1 for an example of Radial Configuration.

“SCADA”: Supervisory Control And Data Acquisition. This is the system that communicates with the generator controls and the power network, to provide overall control and monitoring of the generator power plant. A SCADA system would typically provide some metering of voltage, current and power for each generator as well as for the entire power-generating plant.

“Time-Overcurrent Protection”: Overcurrent protection where the level of overcurrent and the speed of response of the protective device are proportional. The higher the fault current, the faster the response of the protective device. A standard ANSI curve will be chosen that will effectively protect the cable.

### BRIEF DESCRIPTION OF THE DRAWINGS

These and other features, aspects, objects, and advantages of the embodiments described and claimed herein will become better understood upon consideration of the following detailed description, appended claims, and accompanying drawings where:

FIG. 1 is a single-line diagram of a typical prior-art wind generator power collection system;

FIG. 2 is a single-line diagram of an exemplary embodiment of the power collection network described and claimed herein;

FIG. 3 is a single-line diagram of a first embodiment of an intelligent power collection network, which uses a basic version of a protection system;

FIG. 4 is a single-line diagram of a second embodiment of an intelligent power collection network, which uses an intermediate version of a protection system that is implemented through overcurrent methods.

FIG. 5 is a single-line diagram of a third embodiment of an intelligent power collection network, comprising four transformers and four strings of three generators, which uses an intermediate version of a protection system;

FIG. 6 is a single line diagram of a fourth embodiment of the intelligent power collection network, comprising the network of FIG. 5 with a fifth transformer and a fifth string of three generators added in parallel, which uses an intermediate version of a protection system;

FIG. 7 is a single line diagram of a fifth embodiment of the intelligent power collection network, comprising the network of FIG. 5 with two radial spurs, one with a fifth transformer and three generators and another with two generators, which uses an intermediate version of a protection system; and,

FIG. 8 is a single line diagram of an embodiment of the intelligent power collection network, which uses an advanced version of a protection system.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

Like reference numerals will be used to refer to like or similar parts from Figure to Figure in the following detailed description of the drawings.

### DETAILED DESCRIPTION OF THE DRAWINGS

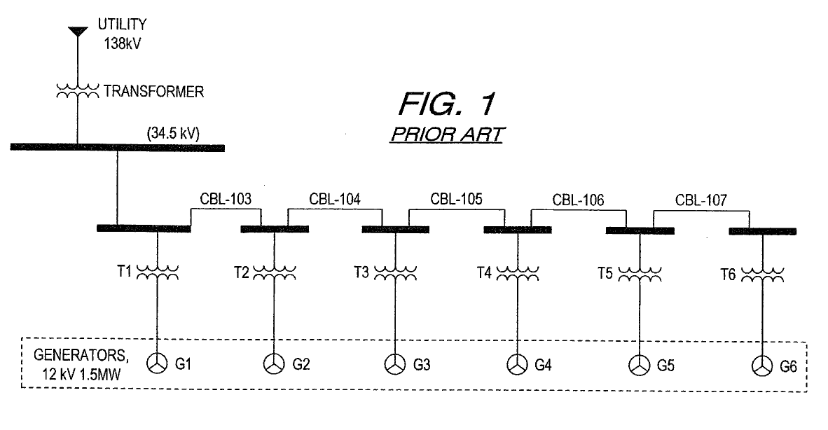

As discussed above, FIG. 1 is a single-line diagram that represents one example of a prior-art power system (or “string”). The prior-art power system is configured according to common practice whereby the system comprises a radial string with one transformer (T1 through T6) per generator (G1 through G6).

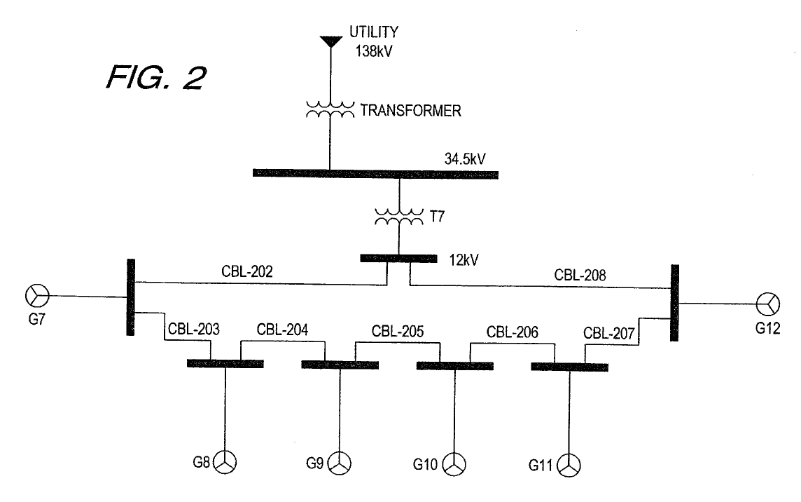

FIG. 2, one the other hand, shows one exemplary embodiment of an intelligent power network that deviates from the common practice by reducing the number of transformers. In the embodiment shown in FIG. 2, several generators (G7 through G12) (typically six, although other configurations are possible) are connected together in a 12.0 kV network. The output of this network is then collected and stepped up by a single transformer (T7). By utilizing such a collection network, the losses are minimized naturally as current flows through the path of least resistance that exists at any given instant. If a fault causes the intelligent network to change its configuration, the currents automatically find the optimum equilibrium for minimizing losses.

The reduced number of transformers results in savings in installation costs. In addition, to reduce power losses, the network of generators is connected to the transformer at both ends. This adds an additional path for the power to flow back to the transformer, reducing the current in each conductor.

Since cable power losses are proportional to the square of the current, the reduction in power lost in the cable can be significant. For example, a reduction in a cable current by one-half results in a 75% reduction in power lost in that cable. It is also found that the power lost in the single larger transformer that collects power from the network of generators is typically less than the sum of the losses of the individual (smaller) transformers that would have been used in the common industry configuration.

Table 1 below illustrates these advantages by providing a generic study model to compare the industry-standard radial string network (in this case, the network of six 1.5 MW wind turbine generators, G1 to G6, with one 1700 kVA transformer per generator, T1 to T6, as shown in FIG. 1) to one embodiment of an intelligent power network (using the network of six 1.5 MW wind turbine generators, G7 to G12, feeding one 9000 kVA transformer, T7, as shown in FIG. 2). The calculations in Table 1 were performed using SKM Power Tools for Windows (“PTW”) to determine operating power losses in cables and transformers. EcoEnergy employed the DAPPER module of PTW to run a “Load Flow Study.” The component power losses calculated by PTW were then used to calculate operating losses.

Cable lengths were assumed to be approximately 4 rotor diameters for both networks. The transformer data used in the model were taken from two Cooper transformer data sheets. Since X/R ratio was not included on the data sheets, the transformer impedance was set to the datasheet value, and then the X/R ratio in the model was adjusted so that the manufacturer's efficiency data was achieved.

At full-load output, losses in the “standard” string (FIG. 1) were approximately 84 kW, compared to full-load losses of less than 64 kW for the intelligent power network configuration. Connecting the generators in the exemplary network configuration significantly reduces power losses, since current in each conductor is reduced and power lost is proportional to the square of the current.

To place a value on the revenue associated with power losses, a value of $0.07/kilowatt-hour (including lost Production Tax Credits (“PTCs”) and Renewable Energy Certificates (“RECs”)) was used, along with a wind farm capacity factor of 0.35. With these assumptions, the value of the reduced power losses in the intelligent power collection network, as compared to the prior art system, is estimated to be worth approximately $4,300 per six generators, or more than $48,000 per year for all 67 generators in a typical 100 MW plant. This excludes any optimizing of the 34.5 kV portion of the network where similar principles apply.

Installation cost savings for a 67-generator model studied was estimated to be approximately $1.7M. This was based on actual transformer, cable and installation bids. It is believed that greater savings are possible.

TABLE 1

| | Industry Standard (FIG. 1) | | | Econet Design (FIG. 2) | | |
|---|---|---|---|---|---|---|
| | Device | Kw Loss | | Device | Kw Loss | |
| 34.5 kV Cable Losses: | CBL-103 | 9.7 | | | | |
| | CBL-104 | 6.2 | | | | |
| | CBL-105 | 3.49 | | | | |
| | CBL-106 | 1.55 | | | | |
| | CBL-107 | 0.39 | | | | |
| 12.0 kV Cable Losses: | | | | CBL-202 | 6.23 | |
| | | | | CBL-203 | 2.78 | |
| | | | | CBL-204 | 0.69 | |
| | | | | CBL-205 | 0.00 | |
| | | | | CBL-206 | 0.69 | |
| | | | | CBL-207 | 2.78 | |
| | | | | CBL-208 | 6.23 | |
| Transformer Losses: | T1 | 10.44 | | T7 | 44.12 | |
| | T2 | 10.41 | | | | |
| | T3 | 10.39 | | | | |
| | T4 | 10.37 | | | | |
| | T5 | 10.36 | | | | |
| | T6 | 10.36 | | | | |
| LOSS TOTALS: | | | | | | |
| Total 34.5 kV cable losses: | | 21.33 | 25% | | 0.0 | 0% |
| Total 12.0 kV cable losses: | | 0.0 | 0% | | 19.4 | 31% |
| Total Transformer kW losses: | | 62.33 | 75% | | 44.12 | 69% |
| Total cable and xfmr losses, in kW: | | 83.66 | | | 63.52 | |
| Calculate lost revenue, due to power losses, in $/kw: | | | | | | |
| Hours per year: | 8760 | | | | | |
| $ per kWh lost: | $0.07 | | | | | |
| Operating factor: | 0.35 | | | | | |
| Total $/kW of loss, per year: | $215 | | | | | |
| Revenue lost per 6 WTG's per year | | $17,955 | | | $13,633 | |
| Revenue lost per 67 WTG's per year: | | $200,499 | | | $152,231 | |
| Revenue savings per year: | | — | | | $48,267 | |
| Installation cost: | | $4,811,024 | | | $3,083,668 | |
| Installation cost Savings: | | — | | | $1,727,357 | |
| TIME VALUE OF MONEY | | | | | | |
| Interest Rate: | 9.00% | | | | | |
| Years of operation: | 25 | | | | | |
| Present Value of Revenue Savings: | | | | | $474,110 | |
| Present Value of Installation cost Savings: | | | | | $1,727,357 | |
| Total Present Value of Savings: | | | | | $2,201,466 | |
| Future Value of Revenue Savings: | | | | | $4,088,285 | |
| Future Value of Installation cost Savings: | | | | | $14,895,135 | |
| Total Future Value of Savings: | | | | | $18,983,421 | |

Although not quantified here, the redundant cable path that is part of the design will reduce operating losses after faults by allowing faulted cables or generators to be removed from service without affecting other cables or generators. These savings could be quantified in a reliability study. Currently, these savings are a non-quantified bonus.

At least three levels of protection for the intelligent power network are contemplated. The sophistication of the protection scheme can range from “basic” to “intermediate” to “advanced”. The protection scheme chosen should minimize the impact of a fault, keeping the maximum number of generators in operation as is possible, while controlling cost and adding to lifecycle value.

The basic protection scheme provides overcurrent protection and the flexibility to manually isolate faulted cables, for quick recovery.

The intermediate protection scheme improves on the basic scheme, by adding more sophistication and automation to the fault protection scheme, while keeping the transformer count to a minimum. This scheme allows faulted network branches to be identified and taken out of service automatically, while allowing unfaulted network branches to remain in operation.

The advanced protection scheme provides even more sophisticated protection and control, for automated identification and fault isolation of an individual faulted cable or component and immediate fault recovery.

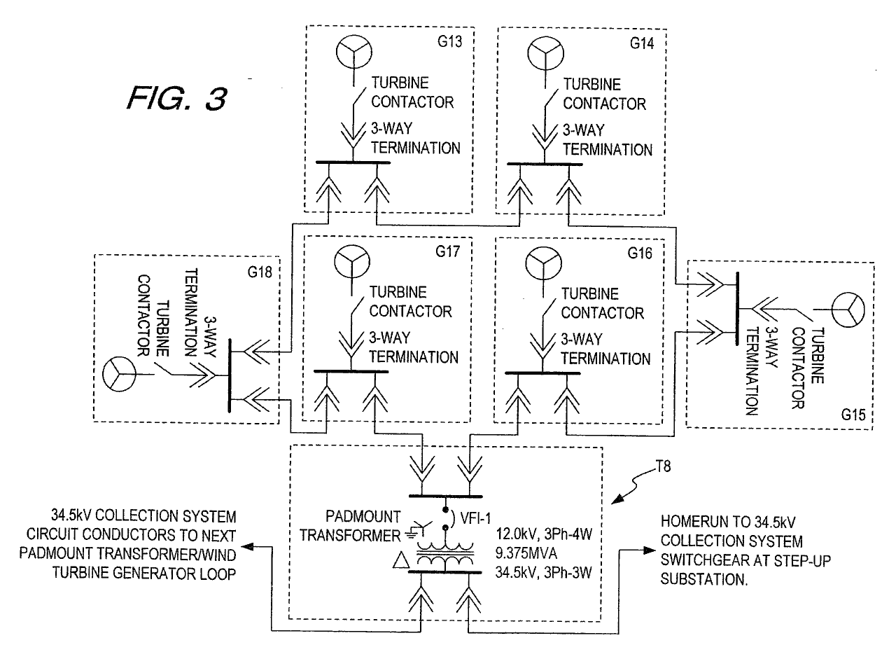

BASIC SCHEME: The Basic protection scheme includes simple overcurrent protection, as shown in FIG. 3. The operating sequence for this scheme is “manual.” A fault anywhere in the loop will trip the Vacuum Fault Interrupter (VFI) VFI-1 that is part of the padmount transformer assembly T8, disconnecting the entire loop from the rest of the collection system. The internal overcurrent devices (not shown) in one or more generators G13 through G18 might also trip, disconnecting the affected generators from the system. Any tripped interrupting devices will require a manual reset by a qualified operator after the fault is removed, so that the isolated portion of the network can be re-connected to the collection system.

INTERMEDIATE SCHEME: Referring next to the intermediate scheme, the power collection network can be implemented so that the overcurrent protection resides only on the transformers, rather than on the generators and transformers. In this configuration, multiple generators are “collected” by a single transformer. This configuration features:
Lower transformer costs: One transformer serves a string of generators, rather than requiring one transformer per generator. This can be a significant cost reduction.
Fewer protective relays, since protective relays to isolate cable faults are only installed at the transformers, rather than at each generator. One protective relay might typically handle a string of 5 or more generators.
No need to work with generator manufacturer on modification of generation equipment. With the intermediate scheme, the relay-equipped transformers could be used with generators from multiple manufacturers.

In terms of control and protection, there are several options for implementing this scheme. In the first option, directional protection elements would allow the control logic to locate and isolate faults. This might include having the control logic “poll” the various protective relays, comparing directions in which the various relays “see” faults, in order to determine the fault location. Once the fault location is identified, the appropriate breakers would then be tripped by the control logic to isolate the faulted portion of the system. This would allow the remainder of the system to continue to generate power.

Another way to implement this scheme would be to use a system of precise timing and phase determination, such as Schweitzer Engineering Lab's “Synchrophasor” technology, to precisely locate the fault by comparing magnitude and phase relationships between fault currents detected in different parts of the system. This is essentially another method of directional fault detection. By comparing these relationships, the fault could be quickly located and isolated. However, directional relay elements and Synchrophasor technology are both relatively expensive.

A third option could be implemented with simple overcurrent methods. In this third option, the network is broken into segments so that simple time-overcurrent fault detection can then be used to isolate the faulted parts. As will be seen, once the fault is located and isolated, most of the network connections can be restored, thereby restoring the advantages that are realized in a network configuration. The descriptions and operating sequences that follow describe this scheme.

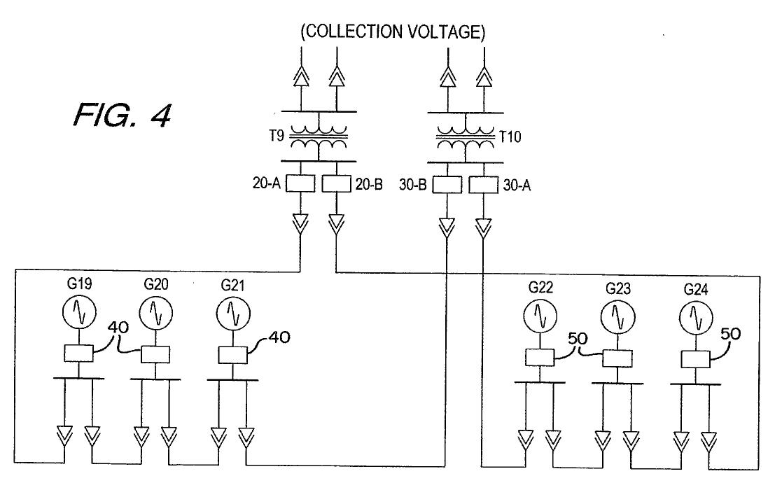

FIG. 4 shows one simple example of how this third option could be implemented. There are two transformers (T9 & T10) that step up the generator voltage (typically 12 kV) to the collection voltage (typically 34.5 kV). In this example, each transformer is rated to accept the power output of three generators (G19 through G21 and G22 through G24), which are connected together in a string. Note that each transformer has two disconnecting devices 20-A/B and 30-A/B that incorporate overcurrent protection relays. These devices could be circuit breakers, vacuum fault interrupters (VFIs), contactors or similar devices. Under normal operating conditions, these disconnecting devices on the transformer low sides are closed, allowing current to flow in two directions from each generator to the transformers. When a fault is detected, the disconnecting devices will open and isolate the faulted string, but the string of generators that was not faulted will continue to operate. More details about the operating sequence that accomplishes this will be discussed later.

Because each string of generators is protected by just two overcurrent devices, this version of power collection network is relatively economical to implement, since fault protection for a long string of generators can be accomplished using just two protective devices. With this configuration, the benefit of current-sharing and redundancy is realized with little added hardware. It should be noted that each generator typically would have its own protective devices, 40 and 50, which would operate independently of the protective devices described and claimed herein.

The following signal definitions apply to the descriptions and operating sequences that follow:

“TRIP-A”: The TRIP-A signal is asserted when any of the 20-A or 30-A disconnecting devices detect an overcurrent. The TRIP-A signal trips all of the -A devices (both 20-A and 30-A in this example) in the network, via a communication loop. The TRIP-A signal allows the network to be broken into isolated segments, so that faults can be isolated.

“TRIP-B”: The TRIP-B signal trips the particular -B device that detected an overcurrent (this would have occurred after the -A devices have tripped open), plus it trips the generators in the associated string. The TRIP-B signal will also trip a lockout relay (not shown) of the -A device that is at the other end of the string, via the communication loop.

“CLOSE-A”: The CLOSE-A signal is fed to all -A devices, after the fault has been isolated. The purpose of this signal is to place any unfaulted generator strings back into operation after the faulted string has been isolated. When CLOSE-A asserts, all -A devices that are not locked out will close. Any -A devices that are locked out will not be closed by this signal.

### EXAMPLES OF INTERMEDIATE SCHEMES

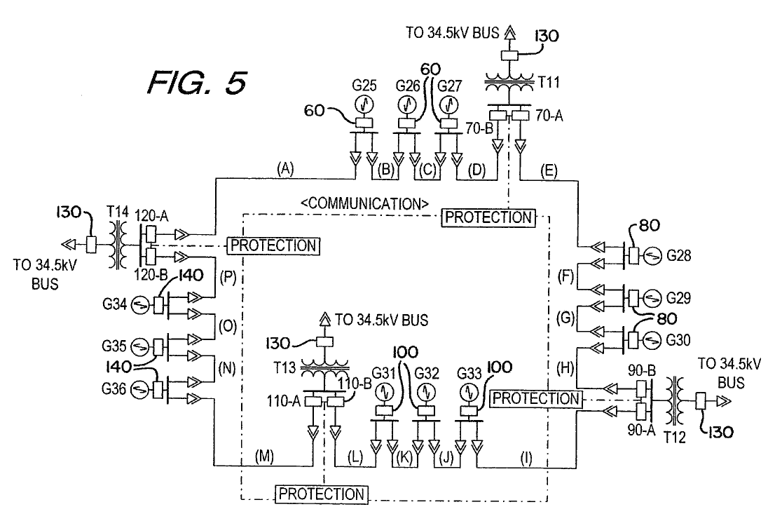

The network complexity can vary. Examples in FIGS. 5-7 show three levels of complexity.

### Example 1

To collect power from twelve generators via four transformers, as depicted in FIG. 5. For simplicity, assume that each transformer (T11-T14) is rated to collect from three generators (for a total of twelve generators, G25-G36). As shown in FIG. 5, each transformer has two disconnecting devices; one -A device and one -B device (70-A/B, 90-A/B, 110-A/B, and 120-A/B), on the generator side of the transformer, and one disconnecting device 130 on the high side of the transformer. The TRIP-A signal is generated when current exceeds an instantaneous threshold in any of the -A devices. In contrast, the TRIP-B signal for each -B device (e.g., 70-B, 90-B, 110-B, and 120-B in the Figure) will only assert when the trip threshold for that -B device is exceeded. The TRIP-B signal is only wired to the particular -B device associated with that relay, plus the associated generator breakers, and the lockout relay for the -A device that is at the other end of the string. A time-overcurrent element (such as an ANSI 51 device) would be used to assert TRIP-B.

The sequence that follows a fault can be briefly outlined as follows:
When a fault is detected, the TRIP-A signal asserts, and all -A devices (70-A, 90-A, 110-A, and 120-A) are opened, breaking the loop into N segments. Each string of generators is now connected to only one transformer. In the example of FIG. 5, the network of generators is broken into four separate strings when the -A devices trip open.
Assuming that the fault still exists after the -A devices have tripped, the fault will now only affect one string of generators, and the relay associated with the -B device that is still feeding that fault will generate a TRIP-B signal, opening that particular, associated -B breaker. None of the other -B devices should trip, since they are not “seeing” any faults now. Note that a -B device could be tripped by either a cable fault or a generator fault.
The TRIP-B signal from any -B device will trip the lockout relay (not shown) at the -A device at the other end of the string of WTGs associated with that -B device.
The TRIP-B signal will also trip each generator breaker in the segment where that TRIP-B signal was generated (e.g., 60, 80, 100, or 140). Although this might not be strictly necessary in the case of induction generators, it would be necessary with synchronous generators.
-B devices that are not feeding a fault will remain closed. The string that has the generator or cable fault is isolated from the network when the -B device opens.
After the faulted generator segment is disconnected, the loop operation can be restored to the generators that are still operating, by reclosing all but two of the -A breakers, in accordance with the control logic. In the case of FIG. 5, this would result in four transformers feeding three strings of generators. Note that this restores some of the current-division and path redundancy that was present before the fault occurred.

Because instantaneous overcurrent cannot be selectively coordinated, it is frequently avoided in many protection schemes. However, in this application, instantaneous overcurrent is used as a fault detector, to initiate the TRIP-A signal. Selective coordination is thus not required. All -A breakers receive the TRIP-A signal at the same time, so they are all opened at essentially the same time. The TRIP-A signal effectively configures the network to a state which will allow further isolation of the fault.

Note that there is selective coordination between the TRIP-A and TRIP-B signals, in the sense that the TRIP-B signal will always assert after the TRIP-A signal has broken the network into segments. In other words, the TRIP-B signal, because it is based on the time-overcurrent curve, is selectively coordinated with TRIP-A.

The operating sequence, in response to a fault, is described below.

### Example 2

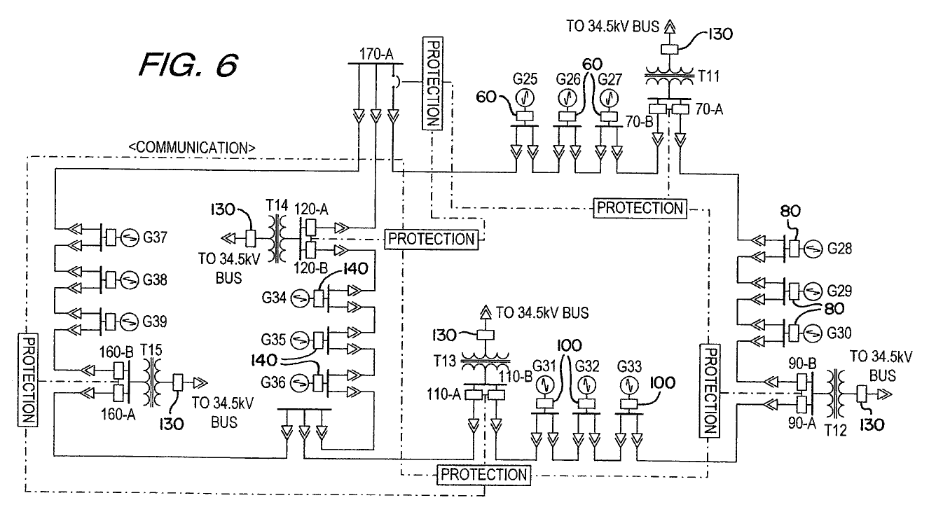

FIG. 6 depicts a slightly more complex network. In this case, we have added another transformer T15 and string of generators G37 to G39, in parallel with one of the strings in the network of FIG. 5. The additional transformer T15 includes two disconnecting devices; one -A device and one -B device (160-A, 160-B), on the generator side of the transformer, and one disconnecting device 130 on the high side of the transformer. The resulting network is one realistic way in which wind turbine generators, for example, might be connected to accommodate their physical layout, while minimizing the length of cables.

In order to properly segment this network, a piece of switchgear 170-A should be added to allow the appropriate segmentation, as shown in FIG. 6. Device 170-A merely needs to be capable of being tripped in response to the TRIP-A signal, and reclosed again remotely by the CLOSE-A signal.

### Example 3

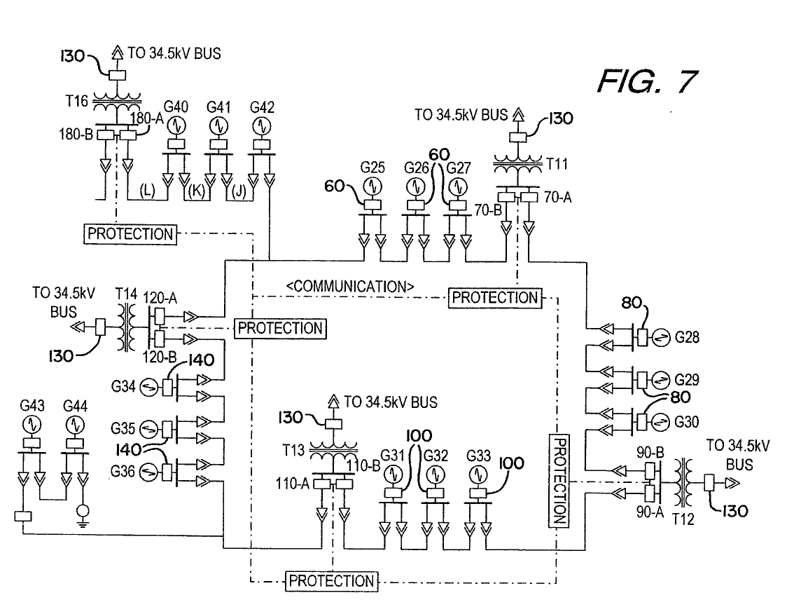

FIG. 7 shows an example of a network where four strings are connected in a “loop” fashion, and five additional generators G40 to G44 and on transformer T16 are added as radial spurs. The operating sequence would be very similar to that for FIG. 6. The additional transformer T16 includes two disconnecting devices; one -A device and one -B device (180-A, 180-B), on the generator side of the transformer, and one disconnecting device 130 on the high side of the transformer. The -A device, 180-A, in the radial spur would have to be treated the same as the 120-A device that is connected to T14. In other words, this 180-A device would be locked out if the Ti 170-B device trips, and would be re-closed by the CLOSE-A signal if it is not locked out.

Operating Sequences for the Intermediate Protection Scheme:

The following operating sequences specifically describe the system shown in FIG. 5, but can also be adapted and applied to the examples shown in FIGS. 6 and 7.

The intermediate scheme has four operating sequences. The sequences are:
1. Normal Operation: All breakers are closed, and all cables are in operation. Protection elements are monitoring currents.
2. Network Fault: A fault has occurred in a cable, generator or transformer.
   a. Generator Fault: A short-circuit has occurred in a generator. Until the fault is isolated, current flows into the fault from other generators on the network as well as from the utility.
   b. Cable fault: A cable is faulted, due to insulation failure or an excavation accident. Until the fault is isolated, current flows into the fault from other network generators as well as from the utility. For reference purposes, the cables in FIGS. 5 are designated (A) through (P).
   c. Transformer Fault: An internal transformer failure causes excessive current to flow into the generator side of the transformer. Until the fault is isolated, current flows into the fault from the utility, as well as from network generators. The protection elements cannot interrupt the fault current that flows from the utility, but they can act to interrupt fault current the transformer.
3. Breaker Failure: A breaker fails to open after receiving a trip signal. The network takes alternate action to mitigate the fault problem.
4. Communications Loss: This is an abnormal condition where the communications channel that is used to provide communications between various components of the system has failed, thereby degrading the protection system.

The sequences below will describe the operating sequences for the system shown in FIG. 5.

Each transformer is connected into the network via two breakers XX-A and XX-B (e.g., 70-A and 70-B for transformer T11 and so forth). Each breaker has both an instantaneous overcurrent element and a time-overcurrent element associated with it, such as ANSI 50 and 51 standard devices, respectively. A trip of the instantaneous element in any relay results in the TRIP-A signal asserting. The TRIP-B signal, based on the time-overcurrent element in each relay, trips that particular breaker, the generator breakers in the associated string, and the -A device at the other end of the string.

Sequence: Normal Operation

The following sequence applies to FIG. 5:
The 34.5 kV side of each transformer is connected to the transmission grid through the collection substation.
All breakers are closed.
Generators are producing output power and current according to their capacities and the requirements of the load on the network. In normal operation, some generators can feed current to the collection network via two possible paths; others that are part of a radial spur can deliver current via only one path. The exact magnitude of the currents in each path are dependent on circuit impedances and generator output power; equilibrium is self-stabilizing.
Protective relays monitor current through each -A and -B device.
The communication system is not in a faulted condition; all communications are normal.
The system is prepared to generate a TRIP-A signal if excessive current is detected in any -A device.
The system is prepared to generate a TRIP-B signal if excessive current is detected in any -B device for a sufficiently long time.

Network Fault Sequences:

The following operating sequence applies to the intermediate configuration, when a fault occurs in a cable, generator or transformer. In any of these three cases, overcurrent conditions should be detected in one or more -A devices or -B devices.

For a fault in the generator that is not isolated by the internal overcurrent protection of the generator, an overcurrent would be detected in the -A devices, opening all -A devices. After the network is segmented, a -B device will trip to disconnect the generators in that string from the collection transformer. It is possible that the internal generator overcurrent protection would trip first. In that case, the network, except for that generator, could be restored.

For a fault in a transformer, fault detection would occur because the generators are feeding fault current into the low side of a faulted transformer. The -A and -B devices are non-directional, so they would trip as described in the sequence below.

Refer to FIG. 5. Each transformer is connected into the loop via two breakers. One is designated XX-A and the other is designated XX-B. The two breakers react differently in response to overcurrents and the distinction between them is important. Each breaker has both instantaneous and time-overcurrent detection elements. Each relay has two outputs: TRIP-A is a common trip signal line that will trip all the -A breakers through the communication system. The TRIP-B output of each relay trips:
The breaker associated with that relay;
The generator breaker or contactor for every generator in that string.
A lockout relay for the -A device at the other end of that generator string (not the -A device that is connected to the same transformer secondary.)

The following example assumes a cable fault on Cable K (FIG. 5).
1. Fault current flows into Cable K, from both directions. Some of that fault current comes from the generators in the network, but most of it comes from the utility, through the transformers.
2. No matter where the fault current comes from, it will exceed the threshold set for the instantaneous overcurrent element of one or more of the -A devices. Because the -B device relays are using time-overcurrent devices, the -A devices will act first. Which of the -A devices detects the fault first does not matter. The first relay to detect the fault asserts the TRIP-A signal for all -A devices.
3. The TRIP-A signal causes all -A devices (one for each transformer) to trip. Once the -A devices are all open, the network is broken into segments, allowing the -B devices to isolate faulted cables.
4. Now that the network is segmented into strings, the -B device feeding the faulted string will trip on overcurrent. In the example of a cable fault at Cable K, T13's 52-B device (110-B) will trip. Any -B device that trips will be locked-out until manually reset.
   a) Each TRIP-B signal is also “wired” to trip all the generator breakers in that string, in case the generators are capable of supplying fault current after the utility is disconnected. In the example above, the TRIP-B signal will trip generator breakers 100 for each generator G31 to G33 in the same string as Cable K.
   b) The TRIP-B signal also trips the lock-out for the -A device at the other end of the generator string. In the example above, the TRIP-B signal also trips the lockout relay (not shown) for the -A device that is connected to T12, 90-A. Once locked out, 90-A has to be manually reset.
   c) The TRIP-B signal is unlatched when the -B device opens. A definite time delay DELAY-B begins timing. If another TRIP-B would assert, DELAY-B would be reset and begin counting again.
5. After DELAY-B times out, the CLOSE-A command causes all -A devices to be reclosed, except any that have been locked-out. In this example, 90-A would remain open, because it was locked out. This would allow the benefits of parallel current paths to be restored to the generators in the remaining “healthy” strings.
6. A SCADA signal is transmitted for notification of the fault.
7. The network is now in a condition in which a string of affected generators is disconnected and locked out, but the remaining generators can continue to operate in the networked fashion.

Similar fault sequences would be applied to more complex networks, such as those shown in FIGS. 6-7.

Breaker (Type-52 Device) Failure Sequence Refer to FIG. 5. When a breaker (such as an ANSI “52” (e.g., a -A or -B)) device fails to trip as commanded, the system reacts accordingly, to isolate the failed breaker to the extent possible.
If any -A device should fail to trip, then the following shall occur:
   The -B device at the other end of the connected generator string shall trip. For example, if device 70-A that is part of T11 fails to trip, then the TRIP-B signal for T12 shall be asserted. As a result, 90-B will be tripped, all generator breakers 80 in that string will be tripped, and the lockout relay for the failed 70-A device shall be tripped. (The lockout of 70-A might also be via software, rather than via an electro-mechanical lockout relay.)
   Note that if the fault is due to a faulted cable in the adjacent string, the -A device that failed to trip could still be feeding fault current into the faulted cable. Overcurrent protective elements on the 34.5 kV side of the associated transformer would be the backup over-current protection in that case. In the example above, the breaker 130 associated with T11 would open for backup over-current protection.
   A SCADA signal would be transmitted for notification of the fault location, and that a breaker had failed.
If any -B device should fail to trip, then the following sequence shall be followed:
   The TRIP-B signal will have already sent a trip signal to the generator breakers in that string, disconnecting all generators from the string.
   If the fault is due to a cable fault, backup protection on the 34.5 kV side of the transformer (i.e, breaker 130) would have to act to interrupt the fault current.
   A SCADA signal would be transmitted for notification of the fault location, and that a breaker had failed.

Similar breaker failure sequences would be applied to more complex networks, such as shown in FIGS. 6-7.

Communications Failure Sequence:

The power network described herein is typically implemented in systems of generators that are separated by thousands of feet, so communication between the protective relays and controls is important for proper operation. Therefore, it is important for the system to recognize when communications have failed, and to operate accordingly.

The communications system is designed with a supervisory monitoring feature, so that the failure of the communications channel or any element of it will result in a COMM FAULT detection. Upon detection of a COMM FAULT, the following occurs:
1. Because of the communications fault, it can be assumed that a TRIP-A signal will not reach all -A devices. However, the relays for each -A device can still trip the associated breaker, upon detection of sufficient fault current. It cannot be guaranteed that all -A devices will trip in this case, unless they see sufficient fault current before the current path is interrupted by another -A device. Chances are, most -A devices would trip anyway due to overcurrent, even without the TRIP-A signal.
2. Overcurrent protection is also still available locally in the -B devices. Cable faults and overloads can still be detected, locally, via detection of overcurrent in each cable. Any -B device that trips will also trip the generators in the associated segment, if possible.
3. Any action in the normal cable fault sequence that would normally require network communication with other segments will not be taken. This includes:
   a) Lockout of the -A device at the other end of the string from the tripped -B device.
   b) There will be no reclosure of the -A devices, because this would require network-wide communication. Instead, the network will remain segmented.

A Note About SCADA and Metering:

The intermediate and advanced systems both communicate with a power plant SCADA system, to report information about type-52 (-A or -B) device states and metering. Any open type-52 device would be reported to the SCADA system. Depending on the options chosen for the system, metering of both voltage and current could be incorporated, so that power could also be calculated and reported. The intermediate and advanced systems have the ability to be programmed to customize other measurements and I/O (Input/Output).

Operating Sequences—Advanced System

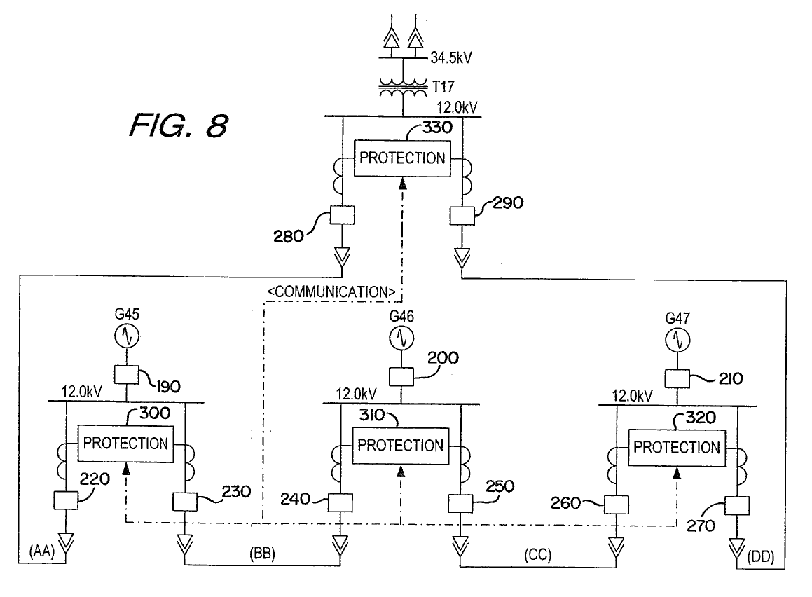

The advanced system defines four operating sequences, in either a loop configuration (e.g., as shown in FIG. 8) or a radial configuration (e.g., as shown in FIG. 8 with connection D removed). A power plant might include a mix of both loop and radial generator strings. The sequences are:
1. Normal Operation: All breakers are closed, and all cables are in operation. Protection elements are monitoring conditions.
2. Network Fault: A fault has occurred in a cable, generator or transformer.
   a. Generator Fault: A short-circuit has occurred in a generator. Until the fault is isolated, current flows into the fault from other generators on the network as well as from the utility.
   b. Cable fault: A cable is faulted, due to insulation failure or an excavation accident. Until the fault is isolated, current flows into the fault from other network generators as well as from the utility.
   c. Transformer Fault: An internal transformer failure causes excessive current to flow into the generator side of the transformer. Until the fault is isolated, current flows into the fault from the utility, as well as from network generators. The protection elements cannot interrupt the fault current that flows from the utility, but they can act to interrupt fault current the transformer.
3. Breaker Failure: A type-52 device or other type of breaker fails to open after receiving a trip signal. The network takes alternate action to mitigate the fault problem.
4. Communications Loss: The communications channel that is used to provide communications between various components of the system has failed, thereby degrading the protection system.

Refer to FIG. 8. For simplicity, only three generators, G45-G47, are shown. Note that the protection and communication elements and breakers that are shown in FIG. 8 could be incorporated within the generator OEM switchgear, or they could be located in separate switchgear that is located near the generator. For example, in a wind turbine application, the elements could be included in the switchgear that is part of the tower assembly, or it could be located in separate pad-mount equipment, placed outside the tower. The specific voltages shown on FIG. 8 are merely examples. In fact, this and other systems described and claimed herein can operate with a wide range of voltages.

Normal Network Operation Sequence:

The following sequence applies to both loop and radial circuits:
The high side (in this example, 34.5 kV) of transformer T17 is connected to the transmission grid through the collection substation. The transformer low side (in this example, 12.0 kV) is connected to the generators.
All breakers (190, 200, 210, 220, 230, 240, 250, 260, 270, 280, 290) are closed.
Generators are producing output power and current according to their capacities. In normal operation, each generator can feed current to the collection network via two possible paths, when configured with a loop topology. The exact magnitude of the currents in each path are dependent on circuit impedances and generator output power; equilibrium is self-stabilizing.
The protection system effectively compares current direction and magnitude at both ends of each cable, via remote communication with electrically-adjacent control modules. When the current flowing into a cable does not equal the current flowing out the other end of a cable, a fault will be detected. This differential scheme is the primary means of cable fault detection.
Each protection module 300, 310, 320, and 330 also applies time-overcurrent protection, to detect short-circuit and overload current conditions in each cable. This protection, slower than the differential protection, serves as a backup to the differential scheme.

Network Fault Sequence:

The protection circuits measure direction and magnitude of current flow through each breaker. The protection modules 300-330 communicate with each other and compare these directions and magnitudes with electrically-adjacent units in the circuit. By communicating with adjacent protective elements this way, the protection system is able to locate and isolate a faulted cable, through a differential protection scheme.

For reference purposes, the cables in FIGS. 8 are designated (AA) through (DD). The following example assumes a cable fault on Cable BB, between generators G45 and G46. (See FIG. 8)
Fault current flows into Cable BB, via breakers 230 and 240, from the utility and from each generator.
The protection elements detect a net current flow into Cable BB, and trip 230 and 240, to isolate Cable BB. The threshold for this detection is sensitive and fast-acting.
Any tripped breaker is locked out until it is manually reset.
A SCADA signal is sent for notification of the fault.

Circuit Breaker Failure Sequence:

Refer to FIG. 8.

When a circuit breaker (220, 230, 240, 250, 260, 270, 280, 290) fails to trip as commanded, the system reacts accordingly, to “work around” the failed breaker, to the extent possible. If any circuit breaker should fail to trip, then the following shall occur:
An adjacent (connected to the same generator bus) closed breaker shall receive a TRIP signal. For example, a 240 failure would result in a TRIP signal being sent to 250. Similarly, a 230 failure would result in a TRIP signal being sent to 220.
If the adjacent breaker fails to trip, then breakers of the electrically-adjacent modules will receive a trip signal.

For example, suppose that breaker 230 is commanded to trip, but fails to. Then a TRIP signal will be sent to 220. If 220 fails to trip, then 240 and 280 will be tripped.

Communications Failure Sequence:

The communications system is designed with a supervisory monitoring feature, so that the failure of the communications channel or any element of it will result in a COMM FAULT detection. Upon detection of a COMM FAULT, the following occurs:
Differential detection and protection via remote communications is lost.
Cable faults and overloads can still be detected, locally, via detection of overcurrent in each cable. The backup protection becomes the primary protection.
Without communication with adjacent modules, LBB will be limited to two breakers on the same generator bus.

Network Fault Sequence—(Alternate 1)

This alternate sequence allows the use of lower-cost protection devices. In this scheme, the system normally operates with a closed loop. When a fault is detected, the loop is opened at a designated point, to put the network into a “radial” configuration. Once in a radial configuration, the fault is located by “polling” protective devices, to determine where the fault current ceased to be detected, and hence the location of the fault. The faulted cable is isolated by opening and locking out the breaker at each end. The remaining breakers are closed, bringing all generators back online. This sequence is similar to the sequence for the Intermediate Scheme, with the difference being that here, the protection devices are located at the generators, rather than the transformers.

The following example again assumes a cable fault on Cable BB. Assume that all generators are operating, and all circuit breakers are initially closed. (See FIG. 8).
Fault current flows into Cable BB, via both 230 and 240, from the utility and from each generator.
Instantaneous overcurrent trip outputs from all relays are logically OR'd together and wired to trip 290. As a result, the circuit configuration is changed from loop to radial, which will allow isolation of the fault.
Now that the network is no longer in a “loop” configuration, the faulted cable can be isolated by comparing magnitudes of fault currents. Generators G46 and G47 would also be contributing fault current into Cable BB (via breaker 240), but at a much lower level than the current that is coming from the grid. The protective relay logic determines that 230 should be tripped, since it will have the highest fault current. The trip logic also opens 240, in order to isolate the faulted cable at both ends. Both 230 and 240 are locked open via a Lockout Relay (such as an ANSI 86 standard device type).
Once the faulted cable is isolated, any open breakers except those that are isolating the faulted cable are closed. Closing 290 allows G46 and G47 to be reconnected to the grid.
A SCADA signal is sent for fault notification.
If a breaker should fail to trip, an LBB scheme will trip a backup AC circuit breaker, in the order that follows:
   An adjacent (connected to the same generator bus) closed breaker (LBB will not be sent to a breaker that is already open).
   If the adjacent breaker fails to trip, then breakers of the electrically adjacent protection modules will receive a trip signal

Note that, in a variation of this scheme, time-current coordination might be used to provide selective coordination between breakers after the loop has opened.

Although the inventions described and claimed herein have been described in considerable detail with reference to certain embodiments, one skilled in the art will appreciate that the inventions described and claimed herein can be practiced by other than those embodiments, which have been presented for purposes of illustration and not of limitation. Therefore, the spirit and scope of the appended claims should not be limited to the description of the embodiments contained herein.

We claim:

1. A power distribution system comprising:
a plurality of generators, the output of each generator capable of producing substantially the same voltage; and
a plurality of cables directly connecting the plurality of generators to at least one power collection point, the plurality of cables forming a network that supplies power to the at least one power collection point from at least two separate current paths.

2. The power distribution system of claim 1, wherein each generator provides current to the at least one power collection point via at least two separate current paths.

3. The power distribution system of claim 1, wherein each generator is connected to the network without a transformer.

4. The power distribution system of claim 1, wherein each generator is a three-phase generator.

5. The power distribution system of claim 1, wherein each generator is driven by a wind turbine.

6. The power distribution system of claim 2, wherein each generator is driven by a wind turbine and wherein each generator is connected to the network without a transformer.

7. The power distribution system of claim 1, wherein the network forms a loop.

8. The power distribution system of claim 1, wherein the power collection point comprises a transformer.

9. The power distribution system of claim 1, further comprising at least two overcurrent devices associated with at least one generator to provide differential fault protection to at least one of the current paths from the at least one generator.

10. The power distribution system of claim 9, wherein a plurality of the generators continue to provide power to the collection point in the event of an overcurrent fault.

11. The power distribution system of claim 10, wherein the plurality of the generators provide power to the collection point via at least two separate current paths after an overcurrent fault has been isolated.

12. The power distribution system of claim 6, further comprising at least one fault detection device associated with at least one generator to provide fault protection to at least one of the current paths from the at least one generator, wherein all the generators continue to provide power to the collection point in the event of a fault on the network after the fault has been isolated.

13. The power distribution system of claim 1, further comprising at least two overcurrent devices associated with each of the plurality of generators to provide differential fault protection to the network, wherein all the generators continue to provide power to the collection point in the event of an overcurrent fault after the fault has been isolated.

14. The power distribution system of claim 12, wherein the network is changed from a single-loop configuration to a multiple-segment configuration as a result of the fault isolation.

15. A power distribution system comprising:
a plurality of three-phase, wind-driven generators;
a plurality of cables directly connecting the plurality of generators to the at least one power collection point, the at least one power collection point comprising a transformer and the plurality of cables forming a loop network that supplies power to the power collection point from at least two separate current paths, wherein each generator provides current to the at least one power collection point via at least two separate current paths, and wherein each generator is connected to the network without a transformer between the generator and the network; and
at least two protection devices associated with each of the plurality of generators to provide fault protection to at least one of the current paths from at least one generator, wherein all the generators continue to provide power to the collection point in the event of a fault on the network.

16. A power distribution system comprising:
a plurality of generators, the output of each generator capable of producing substantially the same voltage; and
a plurality of cables directly connecting the plurality of generators to a plurality of power collection points, the plurality of cables forming a network that supplies power to each power collection point from at least two separate current paths.

17. The power distribution system of claim 16, further comprising a plurality of fault protection devices associated with at least two of the plurality of power collection points to provide fault isolation to at least one current path to at least one of the power collection points having the plurality of fault protection devices;
wherein the network configuration is changed from a single-loop configuration to a multi-segment configuration in the event of a fault on the network as a result of fault isolation.

18. The power distribution system of claim 17, wherein each of the plurality of power collection points further comprises at least two fault protection devices;
a communication system coupled to the fault protection devices and being capable of remotely tripping or closing any of the fault protection devices, wherein following a fault the communication system configures the network so that at least one power collection point receives power from the network from at least two separate current paths after the fault is isolated.

19. The power distribution system of claim 18, wherein at least one of the plurality of fault protection devices at each power collection point comprises an instantaneous overcurrent device and at least one of the plurality of fault protection devices at each power collection point comprises a time-overcurrent device.

20. The power distribution system of claim 19, wherein the tripping of a single instantaneous overcurrent device causes the initial tripping of all the instantaneous overcurrent devices via the communication system.

21. The power distribution system of claim 20, the network configured such that tripping all the instantaneous overcurrent devices initially breaks the network into a number of segments equal to the number of power collection points.

22. The power distribution system of claim 21, wherein one of the time-overcurrent devices identifies which segment of the network has a fault after the instantaneous overcurrent devices have all tripped.

23. The power distribution system of claim 22, wherein the fault protection devices may be selectively reclosed by the communication system so that at least one power collection point can receive power from at least two separate current paths after a fault is isolated.
